(19) United States
(12) Patent Application Publication
(10) Pub. No.: US 2006/0132652 A1
(43) Pub. Date: Jun. 22, 2006

(54) Display apparatus, control method thereof and device for processing signal

(76) Inventor: Young-chan Kim, Uiwang-si (KR)

Correspondence Address: Stanzione & Kim. LLP, Suite 440, 919 18th St. NW, Washington, DC, 20006, US

(21) Appl. No.: 11/311,651

(22) Filed: Dec. 20, 2005

(30) Foreign Application Priority Data
Dec. 21, 2004 (KR) 2004-109392

(51) Int. Cl. H04N 5/05; H04N 5/45; H04N 9/455

(52) U.S. Cl. 348/524

(57) ABSTRACT

The present invention relates to a display apparatus including a display part displaying a digital signal that includes a pixel clock, a frequency adjusting part adjusting a frequency of the pixel clock, and a controller controlling the frequency adjusting part to adjust the frequency of the pixel clock of the digital signal to be within a predetermined frequency range.

### CROSS-REFERENCE TO RELATED APPLICATIONS

This application claims the benefit of Korean Patent Application No. 2004-109392, filed on Dec. 21, 2004, which is hereby incorporated by reference for all purposes as if fully set forth herein.

### BACKGROUND OF THE INVENTION

1. Field of the Invention

The present invention relates to a display apparatus, a control method thereof and a device for processing a signal and, more particularly, a display apparatus, a control method thereof and a device for processing a signal adjusting a pixel clock of a received video signal.

2. Description of the Related Art

A conventional display apparatus receives a video signal of a predetermined display mode from a video signal source, such as a computer, a television broadcasting system, etc., thereby displaying a picture on a screen thereof. The display apparatus may be a cathode ray tube (CRT) or a flat panel display, such as a liquid crystal display (LCD) panel, a plasma display panel (PDP), organic light emitting display (OLED), etc.

The flat panel display apparatus receives an analog video signal from a video signal source and converts the analog video signal into a digital video signal, thereby displaying a picture. In that case of the flat panel display apparatus. A processible frequency of a horizontal and vertical synchronous signal of a received video signal is predetermined and the display apparatus displays a processed picture when the frequency of the received video signal from an outside video signal source is within an allowable range. However, the display apparatus does not display a processed picture when the frequency of the received video signal is not within the allowable range.

The flat panel display apparatus comprises an analog/digital (A/D) converter to convert the analog video signal into the digital video signal. When the frequency of the digital video signal converted by the A/D converter not within the predetermined standard range supported by the display apparatus, the digital video signal is processed and downsized or down sampled to the allowable range. The digital video signal is processed according to a preset method and transmitted to a display panel, such as the LCD panel or the PDP, thereby driving a pixel corresponding to the digital video signal and displaying a picture.

However, when the digital video signal is provided to the display apparatus, the digital video signal is not processed by the A/D converter and the digital video signal having a frequency that is greater than a predetermined range is not downsized to an allowable frequency.

FIG. 1 is a control block diagram of a conventional display apparatus. As shown therein, a digital video signal is provided to a display apparatus at operation S1. When the input video signal meets standard requirements of the display apparatus, the video signal is processed and displayed at operation S3.

However, when the input video signal does not meet standard requirements of the display apparatus, e.g., a frequency of the input video signal is greater than a frequency of a predetermined allowable range, the display apparatus does not display the video signal. Instead, the display apparatus displays a black screen by operating the video signal as free running at operation S4.

Thus, the display apparatus does not provide a warning message informing of there being input an unallowable video signal for a predetermined screen, for example a screen for a changing display information on Windows, so that a user may adjust an output screen of the display apparatus to a suitable screen.

### SUMMARY OF THE INVENTION

Accordingly, an aspect of the present invention to provide a display apparatus, a control method of thereof and a device for processing a signal in with processes a digital video signal that is out of a predetermined allowable frequency range.

Additional features of the invention will be set forth in the description which follows, and in part will be apparent from the description, or may be learned by practice of the invention.

The present invention discloses a display apparatus, including a display part displaying a digital signal that includes a pixel clock, a frequency adjusting part adjusting a frequency of the pixel clock, and a controller controlling the frequency adjusting part to adjust the frequency of the pixel clock of the digital signal to be within a predetermined frequency range.

The present invention further discloses a method of controlling a display apparatus, including receiving a digital signal including a pixel clock, detecting whether a frequency of the pixel clock is within a predetermined frequency range, and adjusting the pixel clock to be within the predetermined frequency range, and displaying the digital signal having the pixel clock that is within the predetermined frequency range.

The present invention further discloses a device receiving and displaying a digital video signal having a pixel clock, including a frequency adjusting part adjusting a frequency of the pixel clock, and a controller controlling the frequency adjusting part to adjust the frequency of the pixel clock to be within a predetermined frequency range.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a control flow chart of a conventional display apparatus.

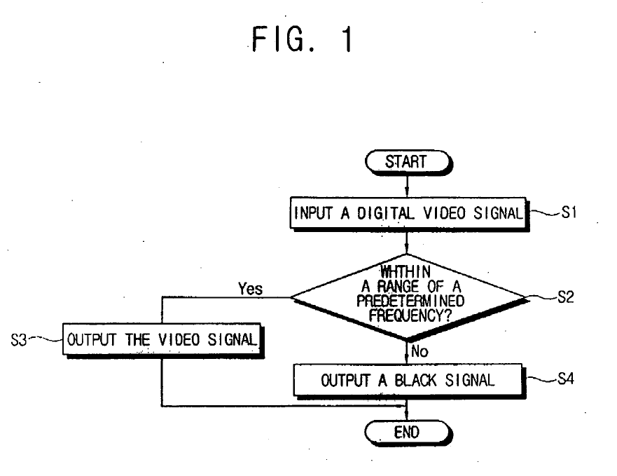

FIG. 2 is a control block diagram showing a display apparatus according to an embodiment of the invention.

FIG. 3 is a schematic view showing an adjusted pixel clock according to an embodiment of the invention.

FIG. 4 is a control flow chart of the display apparatus according to an embodiment of the invention.

### DETAILED DESCRIPTION OF THE ILLUSTRATED EMBODIMENTS

Reference will now be made in detail to the embodiments of the present invention, examples of which are illustrated in the accompanying drawings, wherein like reference numerals refer to like elements throughout.

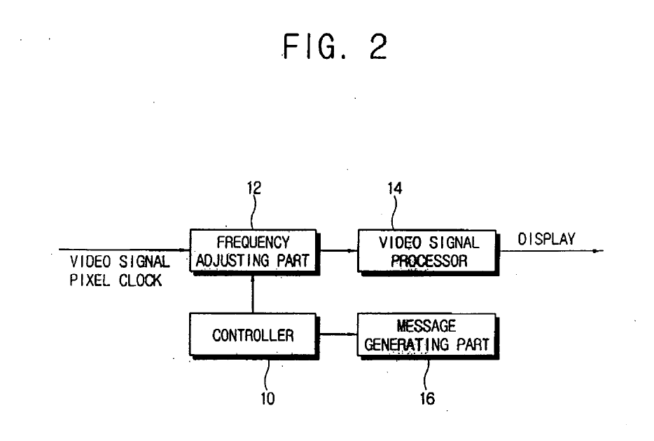

FIG. 2 is a control block diagram of a display apparatus according to an embodiment of the invention. As shown therein, the display apparatus includes a display part that receives a digital video signal, which includes a pixel clock, and displays an image. The display apparatus further includes a controller 10, a frequency adjusting part 12, a video signal processor 14, and a message generating part 16.

The frequency adjusting part 12 adjusts a frequency of the pixel clock. The frequency adjusting part 12 may include a divider that divides the frequency of the pixel clock into a lower frequency of integer proportion thereof. Alternatively, the frequency adjusting part 12 may include a clock modulator to convert the pixel clock to a preset pixel clock.

The divider may divide the frequency of the pixel clock in a half or a quarter to satisfy a predetermined range supported by the display apparatus. The divided frequency of the pixel clock is input to the video signal processor 14. The clock modulator may be provided as a phase locked loop (PLL) that converts the input pixel clock to a preset frequency of the pixel clock.

The message generating part 16 displays information of a changed frequency in the display part when the frequency of the pixel clock is adjusted by the frequency adjusting part 12. For example, the message generating part 16 generates a display informing that the frequency of the pixel clock is changed and the video data is processed according to the changed the frequency of the pixel clock. Further, a screen for adjusting an output picture of the display apparatus, for example a screen having a menu for changing display information, may be provided. The message generating part 16 may include an on screen display (OSD) generating part providing the OSD or an LED display part.

The video signal processor 14 processes the video signal according to the input pixel clock and scales the video signal to a predetermined format according to the display apparatus. The video signal that is processed by the video signal processor 14 is displayed on the display part (not shown). Various types of display parts may used to display a picture. The display part is selected according to the digital video signal, such as a liquid crystal display panel, a plasma display panel, an organic light emitting diode display, etc.

The controller 10 detects the pixel clock of the input digital video signal and controls the frequency adjusting part 12 to adjust the frequency of the pixel clock to be within the predetermined allowable range.

The digital video signal may be input to a transmission minimized differential signaling (TMDS) receiver of the display apparatus, decoded, and converted to the predetermined format necessary for displaying an image on the display part. However, when the pixel clock of the input video signal is not within the predetermined range that is supported by the display apparatus, the video signal cannot be displayed.

Accordingly, the controller 10 determines whether the pixel clock needs to be adjusted by detecting whether the frequency of the pixel clock is within the preset allowable frequency range. When the frequency of the pixel clock is within the predetermined allowable frequency range, the controller 10 controls the digital video signal so that the digital video signal only passes through the frequency adjusting part 12. Alternatively, when the frequency of the pixel clock is not within the predetermined allowable frequency range the controller 10 generates a control signal controlling the frequency adjusting part 12 to divide or modulate the digital video signal.

Further, when the frequency of the pixel clock is changed, the controller 10 may control the message generating part 16 to display the changed information of the frequency.

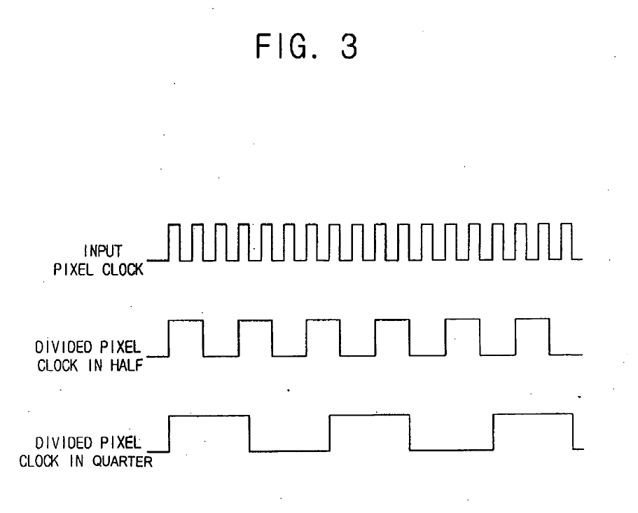

FIG. 3 is a schematic view showing an adjusted pixel clock according to an embodiment of the invention. As shown therein, when the pixel clock input to the frequency adjusting part 12 is not within the predetermined allowable frequency range, the divider divides the frequency of the pixel clock in a half or a quarter. It is understood that the invention is not limited to dividing the image signal into only in half or quarter. For example, the image signal may be divided further into eighths, sixteenths, etc.

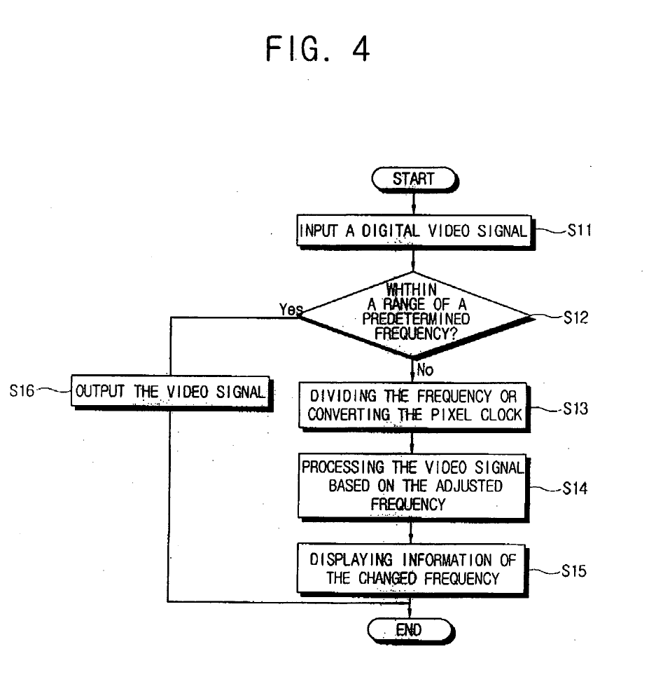

FIG. 4 is a control flow diagram showing a display apparatus according to an embodiment of the invention. As shown in FIG. 4, a digital video signal is input to the display apparatus at operation S11. The controller 10 detects whether the frequency of the pixel clock is within the range of the predetermined allowable frequency that is supported by the display apparatus at operation S12. When the pixel clock is within the range of the predetermined allowable frequency, at operation S16, the controller 10 controls the video signal so that the pixel clock passes through the frequency adjusting part 12 before the video signal is displayed. Alternatively, when the frequency is not within the range of the predetermined allowable frequency, at operation S13, the controller controls the video signal so that the pixel clock is divided or modulated by the frequency adjusting part 12.

The video signal processor 14 processes the video signal according to the adjusted pixel clock at operation 14, and outputs the video signal to the display part. When the pixel clock is divided or modulated, a message generating part 16 may be included in the display apparatus to display the information of the changed frequency. Specifically, the controller 10 may control the message generating part 16 to output a signal to the display part, whereby a user is informed of the changed frequency through a predetermined user interface at operation S15.

The frequency adjusting part 12 and the controller 10 may be provided in the display apparatus or may be provided in a separate device or devices external or mounted to the display apparatus. In other words, the frequency adjusting part 12 and the controller 10 may be any type of device that receives the video signal and displays it. Meanwhile, a separate device is may be provided in the display apparatus.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A display apparatus, comprising:
a display part displaying a digital signal that includes a pixel clock;
a frequency adjusting part adjusting a frequency of the pixel clock; and
a controller controlling the frequency adjusting part to adjust the frequency of the pixel clock of the digital signal to be within a predetermined frequency range.

2. The apparatus of claim 1, wherein the frequency adjusting part comprises:
a divider dividing the frequency of the pixel clock.

3. The apparatus of claim 1, wherein the frequency adjusting part comprises:
a clock modulator converting the pixel clock to a predetermined pixel clock.

4. The apparatus of claim 1, further comprising:
a message generating part providing a message to the display part,
wherein the controller controls the message generating part to display the message when the frequency adjusting part adjusts the frequency of the pixel clock.

5. A method of controlling a display apparatus, comprising:
receiving a digital signal including a pixel clock;
detecting whether a frequency of the pixel clock is within a predetermined frequency range; and
adjusting the pixel clock to be within the predetermined frequency range; and
displaying the digital signal having the pixel clock that is within the predetermined frequency range.

6. The method of claim 5, wherein the adjusting the pixel clock comprises dividing the frequency of the pixel clock.

7. The method of claim 5, wherein the adjusting the pixel clock comprises converting the pixel clock to be within the predetermined frequency range.

8. The method of claim 5, further comprising:
displaying information of the changed frequency when adjusting the frequency of the pixel clock.

9. A device receiving and displaying a digital video signal having a pixel clock, comprising:
a frequency adjusting part adjusting a frequency of the pixel clock; and
a controller controlling the frequency adjusting part to adjust the frequency of the pixel clock to be within a predetermined frequency range.

10. The device of claim 9, wherein the frequency adjusting part comprises:
a divider dividing the frequency of the pixel clock.

11. The device of claim 9, wherein the frequency adjusting part comprises:
a clock modulator converting the pixel clock to a predetermined pixel clock.
